(19) United States
(12) Patent Application Publication
(10) Pub. No.: US 2002/0007278 A1
(43) Pub. Date: Jan. 17, 2002

(54) Speech activated network appliance system

(76) Inventor: Michael Traynor, Ottawa (CA)

Correspondence Address: RADER FISHMAN & GRAUER PLLC, LION BUILDING, 1233 20TH STREET N.W., SUITE 501, WASHINGTON, DC, 20036, US

(21) Appl. No.: 09/900,912

(22) Filed: Jul. 10, 2001

(30) Foreign Application Priority Data
Jul. 11, 2000 (CA) 2,313,717

(51) Int. Cl. G10L 21/00

(52) U.S. Cl. 704/275

(57) ABSTRACT

This invention is for a system and a process that will allow people to use a wireless phone or a wireline telephone to activate and control remote appliances using their spoken voice. The system is comprised of four operating networks: the speech activated control network, the caller's network, the administrative network and the appliance network. A caller initially registers with the speech activated control network to provide voice sample, credit information and assigned PIN. Thereafter, a caller can call the system to selectively instruct the system to perform a specific function by one of the appliances within the appliance network, such as setting a particular appliance in motion or making a purchase from one of the preprogrammed appliances, including effecting secured payments for the transaction. The administrative network maintains data relating to the user as well as the individual remote appliances and the manufacturers of these appliances.

### FIELD OF THE INVENTION

The present invention relates to computer-telephony integration including Internet Protocol network appliances.

### BACKGROUND OF THE INVENTION

Telephones and wireless phones are the most widely used communications appliances in the world. Traditionally, telephones were used as a convenient way for people to communicate between each other when they were physically separated. The recent advancement in the field of speech recognition software and wireless telephony have positively changed the ways telephones are used.

Speech recognition allows computers to understand what people are saying. This technology has evolved to the point where people can simply speak in a conversational manner and have the application understand with a high degree of accuracy. This would have not been possible a few years ago. With the widespread use of wireless phones, there is a unique opportunity to use these communication tools to control appliances using another widespread technology, the Internet, as a transmission facility.

One such usage is to employ the telephones to remotely control certain appliances which have been preprogrammed by the appliance manufacturers to enable communication and interaction between the user and the appliances through the user's voice.

In U.S. Pat. No. 5,465,291 (issued to Barrus et al. on Nov. 7, 1995), it discloses a system in which users may order items at a remote site from a central location with the aid of machine-readable apparatus, such as a bar code reader, via the telephone. Voice confirmation describing the ordered item is sent back over the telephone to the user automatically. However, this system only operates in a wired environment and it requires the assistance of machine-readable information and apparatus.

U.S. Pat. No. 6,026,375 (issued to Hall et al. on Feb. 15, 2000) describes a system which allows a service provider to receive an order from a mobile customer, receive customer location information from a location determination system such as Global Positioning System, and schedule the completion of the customer's order to coincide with the time when the customer arrives at the facility of the service provider. Advanced electronic payments may be arranged to facilitate completion of the purchase. The Hall et al. system is restricted to effecting purchases where live attendants are required. The system also limits itself to making purchases only and is incapable of performing other remote functions.

In Canadian Patent Appln. No. 2,293,786 (filed Jun. 9, 1998 by May), a virtual electronic communication manager is disclosed. This virtual assistant provides an interface between a user using a communication appliance and a data and/or telephone network such that it can receive and interpret a user's voice and retrieve information requested by the user. This system does not, however, allow the user to instruct a remote appliance to perform a specific function such as to affect a purchase.

Accordingly, it is desirable to combine the wired or wireless telephony with voice recognition technology to enable a user to interact with a preprogrammed remote appliance.

### SUMMARY OF THE INVENTION

It is an object of the present invention to provide a method and a system which allow a user to control remote appliances and, if necessary, bill for products and services being delivered by those appliances using spoken voice commands. These appliances can be accessed with any telephone, anywhere in the world—over landline, wireless or satellite transmission facilities.

In accordance with one aspect of the present invention, it provides a speech activated appliance system comprising a callers network for enabling a caller to initiate an instructing telephone call; a speech activated control network for recognizing and authenticating the voice of the caller and processing the caller's instructions directed to a specific remote appliance; an administrative network for interfacing with a manufacturer of the remote appliance; and an appliance network for facilitating the remote appliance to complete a desirable transaction in response to the caller's instructions.

In accordance with another aspect of the present invention, it provides a method of activating remote network appliance comprising a telephone caller providing specific instructions to a speech activated control network to activate a remote appliance; the speech activated control network verifying the caller's voice and processing the specific instructions to the remote appliance via landline or wireless communication and the remote appliance performing the instructed transaction.

### BRIEF DESCRIPTION OF THE DRAWING

In the accompanying drawing which illustrates a preferred embodiment of the invention:

FIG. 1 shows the overall architecture of the system and its operation thereof.

### DETAILED DESCRIPTION OF THE INVENTION

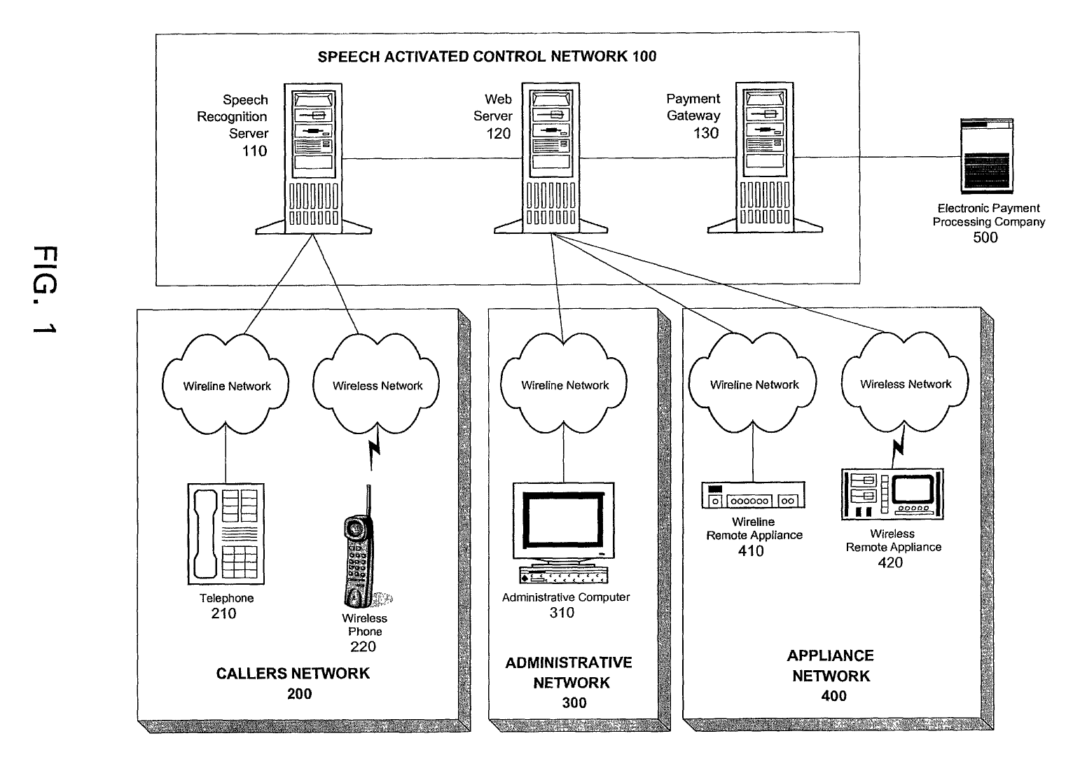

FIG. 1 shows how the system is deployed. Referring to this FIGURE, there are four main networks to the deployment: speech activated control network 100; callers network 200; administrative network 300; and appliance network 400.

The speech activated control network 100 consists of three main components a speech recognition server 110, a web server 120 and a payment gateway 130. The speech recognition server 110 contains commercially available software and hardware that allow it to connect to a voice network and recognize what users are saying using natural language speech recognition. Using this technique, applications are developed which are specific to the manufacturer of each remote appliance (410 or 420) in the appliance network 400. In one scenario, for example, in the case where the remote appliance is a soft drink vending machine 410, the manufacturer wants its machines to be voice activated such that when a user calls the speech recognition server 110, the caller will be prompted to enter an ID number for the specific remote appliance—the soft drink vending machine 410 they wish to control. Every remote appliance would have a label ID number identifying that particular appliance. The label could be a spoken name or IP address. The application according to the present invention then verifies the caller's voice, and the speech recognition server 110 will query the web server 120 for information on the appliance and the caller. Based on the query, the speech recognition server 110 asks the caller whether she/he would like Pepsi™, Sprite™ or Gingerale™. The user asks for Pepsi™ and the speech recognition server 110 directs the web server 120 to carry out the transaction.

There are many uses of this technology—controlling parking meters, air conditioners in buildings, remote alarming, or the ability to allow the police and fire department to control traffic lights, just to name a few. In another scenario, a cellular phone manufacturer builds a car phone with embedded software to allow it to disable the ignition system on a car. Once installed, a person could disable their car by calling into the speech recognition server and instructing the system to turn off the ignition of the car.

Within the speech recognition server 110, every appliance will have a speech recognition application that will have a dialog flow unique to a manufacturers' appliance. This dialog flow will allow callers to speak commands that can be understood by the speech recognition server 110. The speech recognition server 110 will then go to the web server 120 in order to communicate with the remote appliance 410 or 420.

Callers can use either wired telephone 210 or wireless phone 220 that transmits their voice through the callers network 200. The first time a caller connects with the speech recognition server 110, she/he has the option of being prompted to enroll and initialize her/his account. During the enrollment process a voice profile is developed for each caller using voice verification software. The caller will also be prompted to provide certain information such as credit card number, address and PIN number. The voice profile will be used later for voice verification in future transactions. This profile, coupled with the caller's own PIN number provide a very high level of security to prevent fraud.

The web server 120 is equipped with software required to ensure secure transactions over the administrative network 300 and a database that contains information specific for each remote appliance and for each caller. In the case of the soft drink vending machine 410, the web server 120 could have information such as the number and type of cans of pop in each vending machine and how much they cost. As well it would have the callers voice print, their credit card information and billing address. The web server 120 would signal the vending machine to release a can of Pepsi™, and bill the caller on their credit card. Billing occurs through a payment gateway 130, which is part of the speech activated control network 100 and includes commercially available software for securely effecting electronic payments. The payment gateway 130 can be optionally connected to one or more electronic payment companies 500.

Appliance network 400 contains all the remote appliances (for example, 410 & 420) in the system. Inside each remote appliance, e.g., vending machine 410, there is a program, either software or firmware, that operates to control the activities of the machine and communicates with the web server 120. The software will identify the specific appliance or range of appliances in the appliance network 400 and control the activities of those appliances. This software will communicate with the control network's (100) web server 120 via an Internet Protocol (“IP”) connection. The connection can be on any transmission facility that uses Transmission Control Protocol (“TCP”)/IP—for example, an Internet connection, a dial up connection using long distance, or a wireless connection. These remote appliances are connected to the web server 120 over land based, such as in the case of the vending machine 410 or wireless networks using TCP/IP, such as 420.

Administrative network 300 operates through an administrative computer 310. It allows remote appliance manufacturers to add or delete appliances from the appliance network 400, change the billing information of their appliance or alter variables specific to their appliance. The manufacturer using a standard web browser over the Internet can suitably access the administrative network 300.

As can be seen from the foregoing description, depending on the nature of the remote appliances 410 and 420, the caller would be able to control the activity of the appliances and in certain cases make purchases. The location of the remote appliance can be anywhere—in a different part of the city, a different country or directly in front of the caller.

Contained within each remote appliance 410 or 420, is either a software or firmware program specifically developed to control the activities of the appliance. The web server 120 program interface can be customized to adapt to the manufacturers software or firmware program depending on their specifications.

It is to be understood that the embodiments and variations shown and described herein are merely illustrative of the principles of this invention and that various modifications may be implemented by those skilled in the art without departing from the scope and spirit of the invention.

The embodiments of the invention is which an exclusive property or privilege is claimed are defined as follows:

1. A speech activated appliance system comprising:
a callers network for enabling a caller to initiate an instructing telephone call;
a speech activated control network for recognizing and authenticating the voice of the caller and processing the caller's instructions directed to a specific remote appliance;
an administrative network for interfacing with a manufacturer of the remote appliance; and
an appliance network for facilitating the remote appliance to complete a desirable transaction in response to the caller's instructions.

2. The speech activated appliance system of claim 1 wherein the callers network comprises of wired or wireless telephone.

3. The speech activated appliance system of claim 1 wherein the speech activated control network comprises a speech recognition server and a web server, whereby the speech recognition server communicates between the callers network and the web server; and the web server in turn communicates between the administrative network and the appliance network.

4. The speech activated control network of claim 3 further comprises a payment gateway whereby secure debits are affected against remote appliance transactions requiring credit payments.

5. The speech activated control network of claim 3 wherein said payment gateway is connected to an external electronic payment processing company.

6. The speech activated appliance system of claim 1 wherein the administrative network operates through an administrative computer.

7. The speech activated appliance system of claim 1 wherein the appliance network comprises of remote wired or wireless appliances responsive to the caller's instructions through computer program means; said remote wired or wireless appliances are identifiable by the caller when issuing voice instructions through an unique label.

8. The speech activated appliance system of claim 1 wherein manufacturers of the remote wired or wireless appliances are capable of adding or deleting the number of said appliances through computer program means.

9. The speech activated appliance system of claim 8 wherein said manufacturers of the remote wired or wireless appliance are further capable of changing the billing information and other related variables through computer program means.

10. The speech activated appliance system of claim 7, wherein the computer program means is either software or firmware specifically designed to adapt to said appliances to respond to the caller's instructions.

11. The speech activated appliance system of claim 8, wherein the computer program means is either software or firmware specifically designed to adapt to said appliances to respond to the caller's instructions.

12. The speech activated appliance system of claim 9, wherein the computer program means is either software or firmware specifically designed to adapt to said appliances to respond to the caller's instructions.

13. The speech activated appliance system of claim 7, wherein the unique label for the remote appliance is an identification number or an Internet URL address.

14. The speech activated appliance system of claim 1 wherein the caller is required to provide a voice profile and is assigned a personal identification number for security reasons.

15. The speech activated appliance system of claim 3 wherein communications between said web server and appliance network is effected via a Transmission Control Protocol over Internet Protocol.

16. The speech activated appliance system of claim 15 wherein said Transmission Control Protocol over Internet Protocol is an Internet connection, a dial up connection using long distance lines or wireless connection.

17. A method of activating remote network appliance comprising:
a telephone caller providing specific instructions to a speech activated control network means to activate a remote appliance;
said speech activated control network means verifying the caller's voice and processing said specific instructions to the remote appliance via landline or wireless communication means; and
said remote appliance performing the instructed transaction.

18. The method of activating remote network appliance of claim 17 whereby the procedures are carried out through a speech activated system, said system comprising:
a callers network for enabling a caller to initiate an instructing telephone call;
a speech activated control network for recognizing and authenticating the voice of the caller and processing the caller's instructions directed to a specific remote appliance;
an administrative network for interfacing with a manufacturer of a remote appliance; and
an appliance network for facilitating the remote appliance to complete a desirable transaction in response to the caller's instructions.
